(19) United States
(12) Patent Application Publication
(10) Pub. No.: US 2009/0228241 A1
(43) Pub. Date: Sep. 10, 2009

(54) SYSTEM TESTING METHOD THROUGH SUBSYSTEM PERFORMANCE-BASED GENERATOR

(75) Inventors: Miao MA, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/044,618

(22) Filed: Mar. 7, 2008

(51) Int. Cl. G06F 15/00

(52) U.S. Cl. 702/186

(57) ABSTRACT

A system testing method through a subsystem performance-based generator is used to perform tests on a single module performance in a Linux system. The subsystem performance-based generator generates an initial performance testing parameter, and sets a memory occupying space, CPU occupation rate, and I/O performance of a module to be tested according to the testing parameter. After setting the testing parameter, the performance of the whole Linux system is tested through a performance testing tool. Next, another performance testing parameter is generated by the subsystem performance-based generator, and then the system performance test is performed after setting the module to be tested accordingly. Various performance value settings of the module to be tested are dynamically adjusted through the method, and then the performance test of the whole system is performed, so as to accurately find out the bottleneck problem of the performance, thereby improving reliability of the system test.

### BACKGROUND OF THE INVENTION

1. Field of the Invention

The present invention relates to a system testing method, and more particularly to a system testing method through a subsystem performance-based generator.

2. Related Art

The kernel of Linux system includes many system modules, for example, system modules of the system layer (kernel level) or functional modules that are encoded and programmed by a subscriber for realizing certain function. Once the Linux system is booted, the system modules or function modules are loaded into the kernel of the Linux system, so that the functions provided by the system modules or functional modules (briefly referred to as module below) are executed. The memory space and CPU occupation rate occupied by the modules after being loaded into the Linux system directly affect the performance of the whole Linux system. If the programmed modules occupy too much CPU resources or memory space, the system resources that can be simulated by the other modules in the Linux system may be affected, so as to affect the overall system efficiency, or further affect the success rate in assigning the memory space. Therefore, after the module is finished to be programmed, it further needs to test the system performance when the module is loaded into the system. Generally, the common manner includes: after the module is loaded into the kernel of the Linux system, the whole system stability is tested, and then it is observed whether the execution efficiency of the Linux system is reduced or not or the CPU resources are excessively occupied or not after the module is loaded. However, it is a challenging problem how to test the loaded module, and the specific reasons thereof lie in that, although the module can be stably operated in a certain Linux system after being loaded therein, it cannot ensure that the module can be normally operated in other systems, and furthermore, the loaded module may not be operated in a full speed (full load) mode, since the hardware environment is limited, and the testing conditions are complicated.

Different module has a different operation status, so the tested performance data only represents the system performance under the current state, but cannot represent the actual performance of a designated module. Meanwhile, the bottleneck of the whole system performance cannot be effectively found out, for example, I/O problem or memory management defect. As can be known that, the current performance test cannot accurately examine the actual performance of the module under test. In addition, a dependence problem in the usage of system resources exists among the plurality of modules in the Linux system, so the performance of a single module may directly affect the performance of the other modules, which undoubtedly increases the complexity in testing the module performance.

### SUMMARY OF THE INVENTION

In view of the above problems in the conventional art that the complexity in testing the module performance is rather high and it cannot accurately examine the reason for affecting the system performance, the present invention is directed to a system testing method through a subsystem performance-based generator, which simulates various performances of a module to be tested under various different software execution environments through the subsystem performance-based generator, so as to accurately test the performances of the module to be tested under different performance environments, and thus accurately mastering the reason for affecting the whole system performance under different environments, thereby accurately examining each performance of the module to be tested.

In order to achieve the above objective, the method of the present invention includes the following steps. Firstly, a performance testing parameter of a subsystem performance-based generator is initialized. Next, according to the performance testing parameter, the subsystem performance-based generator assigns a memory occupying space, CPU occupation rate, and I/O round-trip time of the module to be tested. Then, the test on the memory, CPU, and I/O performance are performed on the Linux system through a performance testing tool. Then, the subsystem performance-based generator modifies the performance testing parameter according to test results of the performance tests. Finally, according to the modified testing parameter setting, the system test is performed once again and the test results are recorded through the performance testing tool.

In the system testing method through a subsystem performance-based generator according to a preferred embodiment of the present invention, the step of initializing the subsystem includes setting the performance testing parameter and a subscriber demand parameter through a human-machine interface. The performance testing parameter or the subscriber demand parameter may be the memory occupying space, CPU occupation rate, and I/O performance.

In the system testing method through a subsystem performance-based generator according to a preferred embodiment of the present invention, the step of performing tests on the memory of the Linux system further includes: setting a memory occupying space of the module to be tested according to the performance testing parameter; acquiring a situation about a residual memory space of the Linux system; returning an error message, if the residual memory space of the Linux system does not satisfy the memory occupying space of the performance testing parameter; and otherwise, if the residual memory space of the Linux system satisfies the memory occupying space of the performance testing parameter, further determining whether the memory occupying space of the module to be tested satisfies the subscriber demand parameter or not. If the memory occupying space of the module to be tested does not satisfy the subscriber demand parameter, the memory occupying space of the module to be tested is increased through the subsystem performance-based generator and the system test is performed again.

In the system testing method through a subsystem performance-based generator according to a preferred embodiment of the present invention, the step of performing tests on the CPU performance of the Linux system includes: setting the CPU occupation rate of the module to be tested according to the performance testing parameter; acquiring a CPU occupation rate of the Linux system; returning the error message, if the CPU occupation rate of the Linux system is larger than the CPU occupation rate of the subscriber demand parameter; and otherwise, if the CPU occupation rate of the Linux system is not larger than the CPU occupation rate of the performance testing parameter, further determining whether the CPU occupation rate of the Linux system satisfies the CPU occupation rate of the subscriber demand parameter or not.

If the CPU occupation rate of the module to be tested does not satisfy the subscriber demand parameter, the CPU occupation rate of the module to be tested is increased through the subsystem performance-based generator and the system test is performed again.

In the system testing method through a subsystem performance-based generator according to a preferred embodiment of the present invention, the step of performing tests on the I/O performance of the Linux system includes: calculating an I/O performance of the module to be tested in a unit of time; returning the error message, if the I/O performance of the Linux system does not satisfy an I/O performance value of the subscriber demand parameter; and otherwise, if the I/O performance of the Linux system satisfies the I/O performance value of the subscriber demand parameter, further determining whether the I/O performance value setting of the module to be tested reaches the I/O performance value of the subscriber demand parameter or not.

If the I/O performance of the module to be tested does not satisfy the subscriber demand parameter, the I/O performance of the module to be tested is increased through the subsystem performance-based generator, and the system test is performed again.

To sum up, in the system testing method through a subsystem performance-based generator of the present invention, the subsystem performance-based generator is used to simulate the performance settings of the module to be tested, for example, the memory occupying space, CPU occupation rate, and after setting the operating parameter of the module to be tested, the whole system performance test is performed by the performance testing tool. If the obtained overall performance does not satisfy the subscriber demand, a single performance testing parameter is adjusted and the system test is performed again, thereby accurately finding out the performances of the module to be tested under different execution environments.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a system testing method through a subsystem performance-based generator;

FIG. 2 is a system architecture view of a system testing method through a subsystem performance-based generator according to a preferred embodiment of the present invention;

FIG. 3 is a flow chart of a performance test performed on a memory occupying space according to a preferred embodiment of the present invention;

FIG. 4 is a flow chart of a performance test performed on a CPU occupation rate according to a preferred embodiment of the present invention; and

FIG. 5 is a flow chart of a performance test performed on an I/O performance according to a preferred embodiment of the present invention.

### DETAILED DESCRIPTION OF THE INVENTION

The objectives and implementing manners of the present invention are described below in detail through the preferred embodiments. However, the concept of the present invention can also be used in other scopes. The following exemplified embodiments are only intended to describe the objectives and implementing manners of the present invention, but not restrict the scope of the present invention.

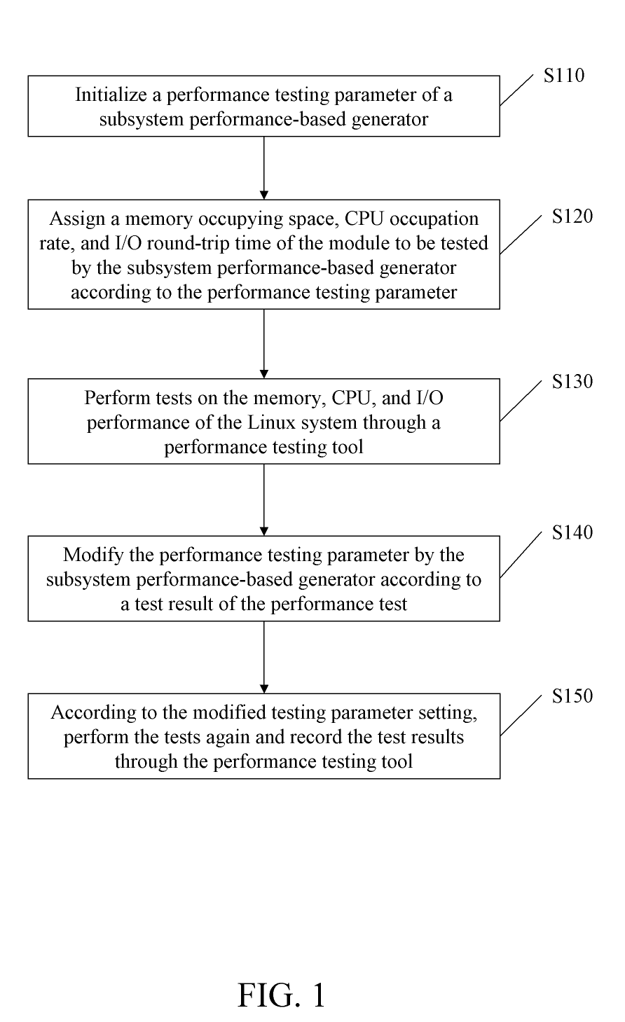

FIG. 1 is a flow chart of a system testing method through a subsystem performance-based generator. Referring to FIG. 1, it is different from the conventional system module test that only the module to be tested is placed into the Linux system to perform the overall performance test. In this embodiment, the subsystem performance-based generator simulates the performance values of the module to be tested under various different software execution environments, for example, the memory occupying space, CPU occupation rate, and I/O performance of the module to be tested under a certain execution environment, so as to accurately test the performance of the module to be tested under different performance environments, and thereby mastering the reason for affecting the overall system performance under the different environments. In this embodiment, the system testing method through the subsystem performance-based generator includes the following steps.

Firstly, a performance testing parameter of a subsystem performance-based generator is initialized (Step S110). Next, according to the performance testing parameter, the subsystem performance-based generator simulates the memory occupying space, CPU occupation rate, and I/O performance of the module to be tested (Step S120). Then, the tests on the memory, CPU, and I/O performance are performed on the Linux system through a performance testing tool (Step S130). Then, the subsystem performance-based generator modifies the performance testing parameter according to test results of the performance tests (Step S140). Finally, according to the modified testing parameter setting, the performance test is performed again and the test results are recorded through the performance testing tool (Step S150).

The step of initializing the subsystem further includes setting the performance testing parameter and a subscriber demand parameter through a human-machine interface. The performance testing parameter and the subscriber demand parameter include three variables (performance parameters), namely, memory occupying space, CPU occupation rate, and I/O performance. In addition, the I/O performance is the number or size of data packets sent by the module to be tested of the Linux system in a unit of time. The CPU occupation rate equation is:

CPU Occupation Rate=Total Time of Specific Process/Total Time of all the Processes.

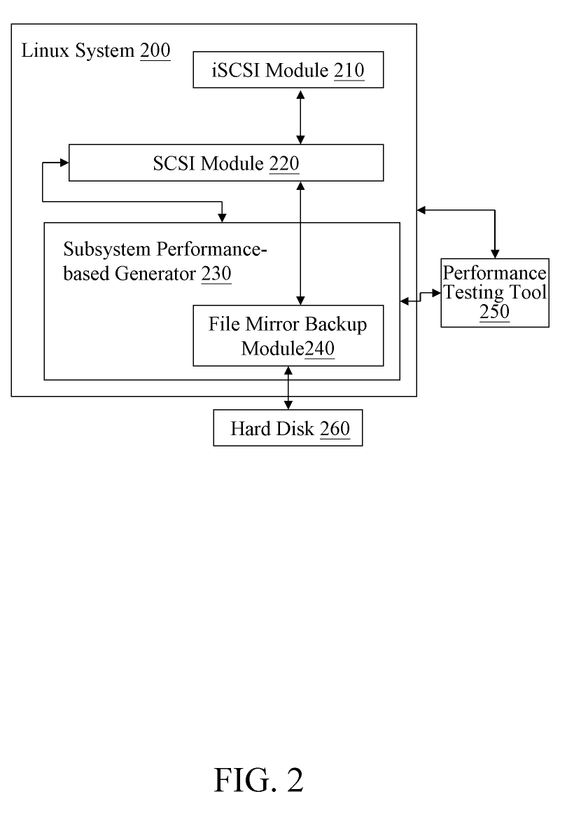

FIG. 2 is a system architecture view of a system testing method through a subsystem performance-based generator according to a preferred embodiment of the present invention. Referring to FIG. 2, in this embodiment, a random module to be tested in a Linux system 200 of a computer is tested. The Linux system 200 includes a plurality of system modules, for example, an Internet small computer system interface (iSCSI) module 210, a small computer system interface (SCSI) module 220, a subsystem performance-based generator 230, a file mirror backup module 240, and a hard disk 260. Each performance of the computer system, for example, the CPU occupation rate, I/O performance, and memory occupying space, is tested through an externally-connected performance testing tool 250. In this embodiment, the module to be tested is, for example, the Mirror module 240. When it intends to test the performance of the Mirror module 240 under different situations, each testing performance of the Mirror module 240 is changed through the subsystem performance-based generator 230, and then the test is performed by the performance testing tool 250. For example, when the whole system test is performed by the performance testing tool 250, the I/O speed of the Mirror module 240 is controlled by the subsystem performance-based generator 230 through time delay, so as to simulate the Mirror module 240 to perform the I/O test at a lower transmission speed.

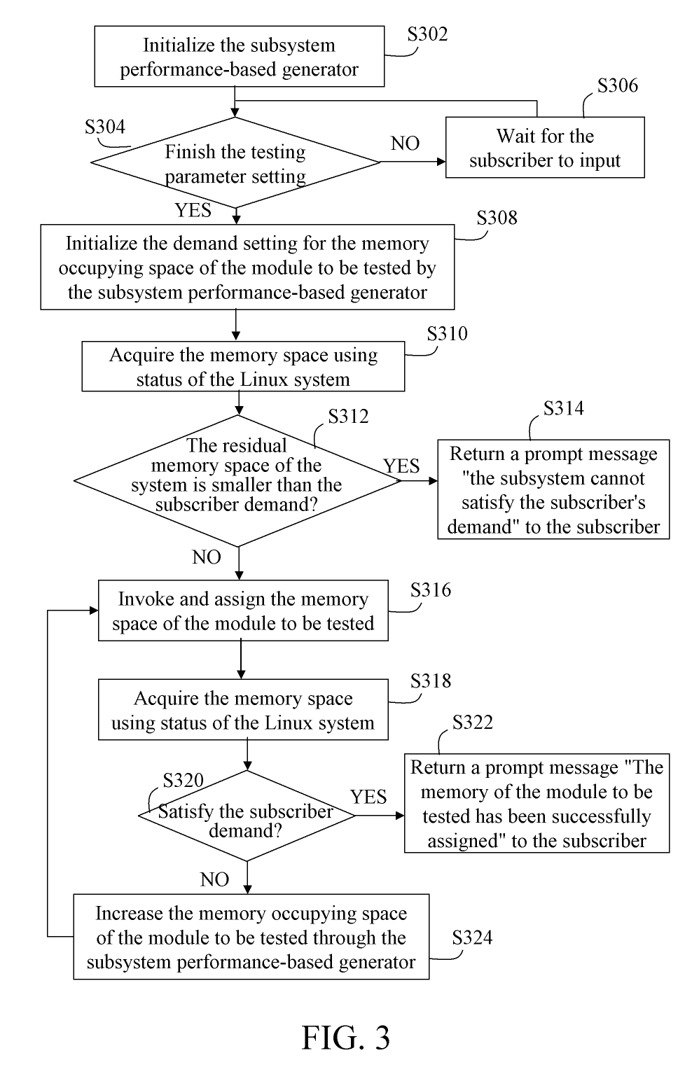

The steps of the performance tests on three performance parameters performed through the subsystem performance-based generator of the present invention are described below. FIG. 3 is a flow chart of a performance test performed on a memory occupying space according to a preferred embodiment of the present invention. Referring to FIG. 3, firstly, the subsystem performance-based generator is initialized (Step S302), in which a predetermined performance testing parameter is read by the subsystem performance-based generator, so as to set a memory occupying space of the module to be tested. In an alternative embodiment, the subsystem performance-based generator is further triggered to generate a human-machine interface, which is provided for inputting the performance testing parameter or a subscriber demand parameter. If the testing parameter setting is not finished (NO in Step S304), it waits for the subscriber to input (Step S306). If the testing parameter setting is finished (YES in Step S304), the demand setting for the memory occupying space of the module to be tested (for example, the Mirror module in this embodiment) is initialized by the subsystem performance-based generator (Step S308). Then, the situation about the residual memory space of the Linux system is acquired by invoking a system instruction (Step S310). If the residual memory space is smaller than the subscriber demand (YES in Step S312), it indicates that the Linux system does not have enough space to execute the module to be tested, at this time, a prompt message (or error message) “the subsystem cannot satisfy the subscriber's demand” is returned to the subscriber (Step S314). If the residual memory space of the Linux system can satisfy the memory demand space in the performance testing parameter, the memory space of the module to be tested is invoked and assigned by the system (Step S316). After the memory space of the module to be tested is assigned, the residual memory space of the Linux system is viewed by invoking the system instruction (Step S318), and the memory using state test of the whole Linux system is performed by the performance testing tool. At this time, it is further confirmed whether the memory occupying space of the module to be tested satisfies the subscriber demand parameter or not (Step S320). If the memory occupying space of the module to be tested does not satisfy the subscriber demand parameter, the memory occupying space is increased through the subsystem performance-based generator, and the system test is performed again (Step S324). On the contrary, if the memory occupying space of the module to be tested satisfies the subscriber demand parameter (YES in Step S320), a prompt message “The memory of the module to be tested has been successfully assigned” is returned to the subscriber.

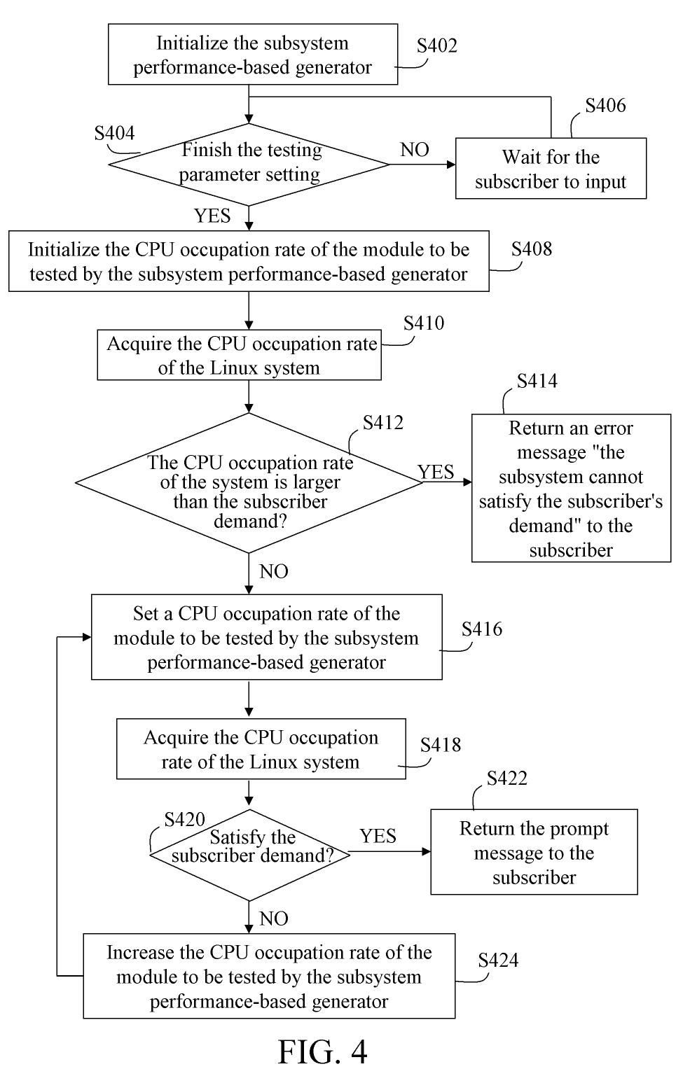

FIG. 4 is a flow chart of a performance test performed on a CPU occupation rate according to a preferred embodiment of the present invention. Referring to FIG. 4, similarly, the subsystem performance-based generator is initialized first (Step S402). Then, it is determined whether the testing parameter setting is finished or not (Step S404). If not, it waits for the subscriber to input (Step S406), otherwise, the CPU occupation rate of the module to be tested is initialized by the subsystem performance-based generator (Step S408), which can be set according to the predetermined performance testing parameter or input by a tester through the human-machine interface. Then, the CPU occupation rate of the Linux system is acquired by invoking a system instruction (Step S410). If the CPU occupation rate of the system is larger than the subscriber demand (YES in Step S412), an error message “the subsystem cannot satisfy the subscriber's demand” is returned to the subscriber (Step S414). On the contrary, a CPU occupation rate of the module to be tested is set by the subsystem performance-based generator (Step S416), and the CPU occupation rate of the Linux system is viewed by invoking the system instruction (Step S418). Then, it is further confirmed whether the CPU occupation rate of the Linux system satisfies the predetermined subscriber demand parameter or not (Step S420). If yes, the prompt message is returned to the subscriber (Step S422); otherwise, the CPU occupation rate of the module to be tested is increased through the subsystem performance-based generator, and the system test is performed again (Step S424).

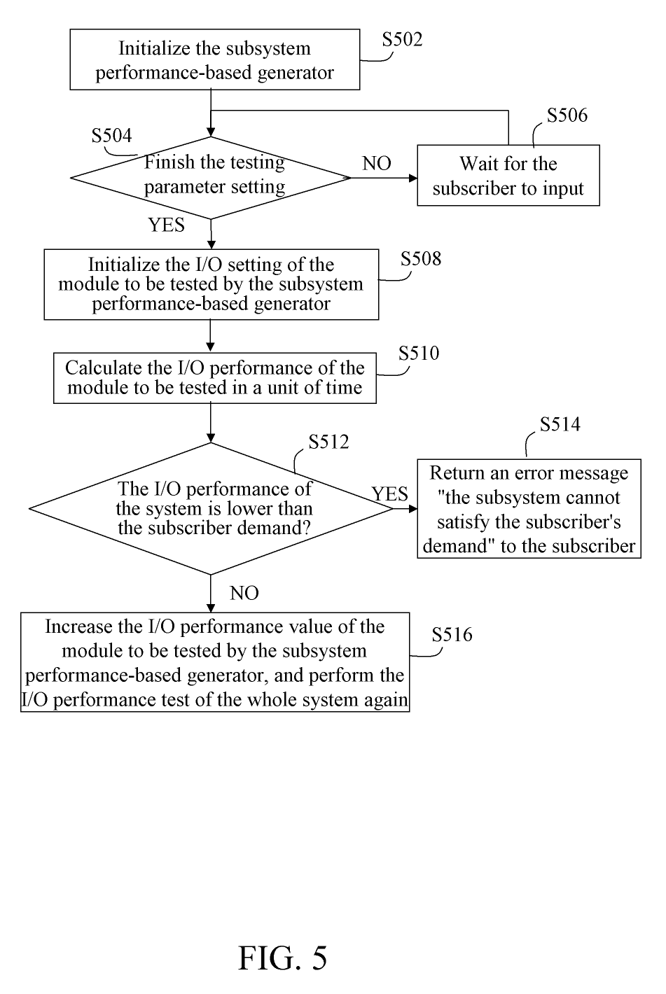

FIG. 5 is a flow chart of a performance test performed on an I/O performance according to a preferred embodiment of the present invention. Referring to FIG. 5, the same as the manner of testing the memory or CPU, the subsystem performance-based generator needs to be initialized firstly (Step S502). Next, it is determined whether the testing parameter setting is finished or not (Step S504). If not, it waits for the subscriber to input (Step S506); otherwise, the I/O set of the module to be tested is initialized by the subsystem performance-based generator (Step S508). Then, the I/O test is performed on the whole Linux system by an externally-connected performance testing tool, and the I/O performance of the module to be tested is calculated (Step S510). If the I/O performance of the system is lower than the I/O performance value of the subscriber demand parameter (YES in Step S512), it indicates that the subsystem cannot satisfy the subscriber demand, at this time, an error message is returned to the subscriber (Step S514). On the contrary, if the I/O performance of the Linux system satisfies the I/O performance value of the subscriber demand parameter, it is further determined whether the I/O performance value setting of the module to be tested reaches the I/O performance value of the subscriber demand parameter or not. If the I/O performance of the module to be tested does not satisfy the subscriber demand parameter, the I/O performance value of the module to be tested is increased through the subsystem performance-based generator, and the I/O performance test of the whole system is performed again (Step S516). In this manner, through dynamically changing the performance parameters with the subsystem performance-based generator, the overall performance value can be tested, and various parameter performances of a certain module to be tested are accurately tested, thereby shortening the developing time, and accurately finding out the performance bottleneck (for example, it can be clearly figure out the I/O particle size at which an interrupt error occurs to the module to be tested).

What is claimed is:

1. A system testing method through a subsystem performance-based generator, for testing a certain module performance in a Linux system, comprising:
initializing a performance testing parameter of a subsystem performance-based generator;
performing a testing parameter setting for a module to be tested by the subsystem performance-based generator according to the performance testing parameter, wherein the testing parameter setting comprises a memory occupying space, a central processing unit (CPU) occupation rate, and an I/O performance;
performing tests on the memory, CPU, and I/O performance of the Linux system through a performance testing tool;
adjusting the testing parameter setting of the module to be tested by the subsystem performance-based generator according to a test result of the module to be tested;
performing tests again through the performance testing tool according to the modified testing parameter setting; and
recording the performance test result.

2. The system testing method through a subsystem performance-based generator as claimed in claim 1, wherein the step of initializing the subsystem comprises setting the performance testing parameter and a subscriber demand parameter through a human-machine interface.

3. The system testing method through a subsystem performance-based generator as claimed in claim 2, wherein the performance testing parameter is selected from one of a group consisting of the memory occupying space, the CPU occupation rate, and the I/O performance.

4. The system testing method through a subsystem performance-based generator as claimed in claim 2, wherein the subscriber demand parameter is selected from one of a group consisting of the memory occupying space, the CPU occupation rate, and the I/O performance.

5. The system testing method through a subsystem performance-based generator as claimed in claim 1, wherein the I/O performance is selected from one of a group consisting of the number of data packets sent in a unit of time and the size of data packets sent in a unit of time.

6. The system testing method through a subsystem performance-based generator as claimed in claim 1, wherein an equation of the CPU occupation rate is:
CPU Occupation Rate=Total Time of Specific Process/Total Time of all the Processes.

7. The system testing method through a subsystem performance-based generator as claimed in claim 1, wherein the step of performing tests on the memory of the Linux system further comprises:
setting a memory occupying space of the module to be tested according to the performance testing parameter;
acquiring a situation about residual memory space of the Linux system;
returning an error message, if the residual memory space of the Linux system does not satisfy the memory occupying space of the performance testing parameter; and
further determining whether the memory occupying spaces of the module to be tested satisfies the subscriber demand parameter or not, if the residual memory space of the Linux system satisfies the memory occupying space of the performance testing parameter, wherein
if the memory occupying space of the module to be tested does not satisfy the subscriber demand parameter, the memory occupying space is increased through the subsystem performance-based generator, and the system test is performed once again.

8. The system testing method through a subsystem performance-based generator as claimed in claim 7, wherein the step of performing tests on the CPU performance of the Linux system comprises:
setting a CPU occupation rate of the module to be tested according to the performance testing parameter;
acquiring a situation about the CPU occupation rate of the Linux system;
returning the error message, if the CPU occupation rate of the Linux system is larger than the CPU occupation rate of the subscriber demand parameter; and
further determining whether the CPU occupation rate of the Linux system satisfies the CPU occupation rate of the subscriber demand parameter or not, if the CPU occupation rate of the Linux system is not larger than the CPU occupation rate of the subscriber demand parameter, wherein
if the CPU occupation rate of the module to be tested does not satisfy the subscriber demand parameter, the CPU occupation rate of the module to be tested is increased through the subsystem performance-based generator, and the system test is performed once again.

9. The system testing method through a subsystem performance-based generator as claimed in claim 7, wherein the step of performing tests on the I/O performance of the Linux system comprises:
calculating an I/O performance of the module to be tested in a unit of time;
returning the error message, if the I/O performance of the Linux system does not satisfy an I/O performance value of the subscriber demand parameter; and
further determining whether the I/O performance value setting of the module to be tested reaches the I/O performance value of the subscriber demand parameter or not, if the I/O performance of the Linux system satisfies the I/O performance value of the subscriber demand parameter; wherein
if the I/O performance of the module to be tested does not satisfy the subscriber demand parameter, the I/O performance of the module to be tested is increased through the subsystem performance-based generator, and the system test is performed once again.
